(19) United States
(12) Patent Application Publication
(10) Pub. No.: US 2010/0145748 A1
(43) Pub. Date: Jun. 10, 2010

(54) INFORMATION TECHNOLOGY PLANNING BASED ON ENTERPRISE ARCHITECTURE

(75) Inventors: Wolfgang Mayle, Crailsheim (DE); Sebastian Rothbucher, Frankfurt (DE)

Correspondence Address: Cantor Colburn LLP-IBM Europe, 20 Church Street, 22nd Floor, Hartford, CT, 06103, US

(73) Assignee: International Business Machines Corporation, Armonk, NY (US)

(21) Appl. No.: 12/330,182

(22) Filed: Dec. 8, 2008

(51) Int. Cl. G06Q 10/00

(52) U.S. Cl. 705/7

(57) ABSTRACT

A method of forming an IT plan for an enterprise utilizing an automated enterprise architecture (EA) system includes creating a project document, the project document describing a particular portion of operations of the enterprise; ranking the criticality of the project as compared to other projects of the enterprise; linking products, including product versions, that are related to the project to the project in the EA system, wherein the link is a two way link; receiving organization technology adoption preferences; and creating a list of products to be upgraded based on the technology adoption preferences and the ranking of the project.

### BACKGROUND

The present invention relates to enterprise architecture, and more specifically, to creating enterprise architecture based assessments.

Enterprise Architecture (EA) has been a topic in information technology (IT) and increasingly in business for several years. Roughly speaking, two ways of working with enterprise architecture have been established. First, EA has been measured by collecting, aggregating and benchmarking (comparing to peer results) of enterprise architecture performance indicators (i.e., number of systems, number of overlaps, percentage of new applications/all applications reviewed, etc.). Secondly, EA has been used to depict the enterprise as a collection of interconnected components (often using several layers, e.g. Business, Applications, IT or other models).

Furthermore, using patterns, best practices and reference models has been a central concept of the enterprise architecture thinking and method(s). However, there has not been a way yet to bring all these aspects together in a structured way to capture both as-is architecture and patterns and to derive indicators from this capture.

### SUMMARY

According to one embodiment of the present invention, a method of forming an IT plan for an enterprise utilizing an automated enterprise architecture (EA) system is disclosed. The method of this embodiment includes creating a project document, the project document describing a particular portion of operations of the enterprise; ranking the criticality of the project as compared to other projects of the enterprise; linking products, including product versions, that are related to the project to the project in the EA system, wherein the link is a two way link; receiving organization technology adoption preferences; and creating a list of products to be upgraded based on the technology adoption preferences and the ranking of the project.

Another embodiment of the present invention is directed to a computer program product for producing an information technology (IT) plan for an enterprise, the computer program product comprises a storage medium readable by a processing circuit and storing instructions for execution by the processing circuit for facilitating a method including: creating a project document, the project document describing a particular portion of operations of the enterprise; ranking the criticality of the project as compared to other projects of the enterprise; linking products, including product versions, that are related to the project to the project in the EA system, wherein the link is a two way link; receiving organization technology adoption preferences; and creating a list of products to be upgraded based on the technology adoption preferences and the ranking of the project.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 shows an example of a computing system on which embodiments of the present invention may be implemented;

FIG. 2 shows a block diagram representation of a hierarchical structure of an EA capturing system according to an embodiment of the present invention;

FIG. 3 shows an example of a metamodel for interconnected artifacts according to one embodiment of the present invention;

FIG. 4 shows an example of two interconnected artifacts that also include a connection support document further describing the connections between the two artifacts;

FIG. 5 shows a method according to an embodiment of the present invention by which one artifact may be linked to another artifact;

FIG. 6 shows a method according to an embodiment of the present invention by which connections between artifacts may be altered; and

FIG. 7 shows another example of interconnected artifacts according to one embodiment of the present invention.

FIG. 8 shows a class diagram for a pattern and a component governed by that pattern according to an embodiment of the present invention;

FIG. 9 shows an instance diagram with actual patterns, standards, and components in the context of a business operation for a more detailed depiction of the system of what may actually occur in an enterprise;

FIG. 10 shows a method of determining the compliance of business enterprise (broken down as components) to required patterns;

FIG. 11 shows a table that may be used to calculate improvement points during the execution of the method shown in FIG. 10;

FIG. 12 shows an alternative interpolation model that may be used instead of or in addition to the table shown in FIG. 11;

FIG. 13 shows a method of obtaining EA information for use in IT planning with the optional step of assigning business criticality;

FIG. 14 shows a method of creating the information for each product that is linked to one or more product versions (and vice versa);

FIG. 15 shows a data flow diagram for providing IT recommendations according to one embodiment of the present invention; and

FIG. 16 shows the details of the IT plan generation.

### DETAILED DESCRIPTION

It has been noted that enterprise architecture (EA) information is rather coarse-grained, very interconnected, highly structured and may be ideal for different views or even reports. In addition, EA information evolves over time and, thus, needs lifecycle management. The prior methods of generating static documents describing EA do not allow for automatic the generation of reports, are not easily alterable and lifecycle management is a de facto manual task because the static documents are not linked in an organized manner allowing for changes in one document to be propagated through other documents in the enterprise architecture.

Embodiments of the present invention may overcome some or all of these drawbacks, and others, by providing a framework for storing structured and interconnected data. Aspects of the present invention provide for interconnected artifacts generated by manual analysis which describe portions of the enterprise. Enterprises can for instance be further described in terms of components (one type of artifact) with additional information such as strategies and principles. These components and other artifacts can be stored in a database system. Indeed, embodiments of the present invention may store and manage over time any type of interconnected EA artifact, thus providing a living asset to develop an enterprise's business and IT capabilities.

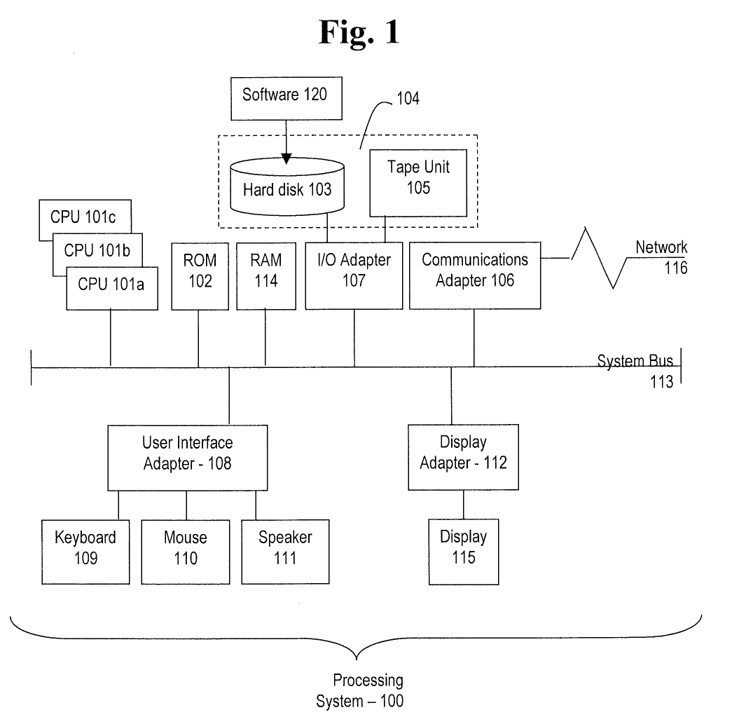

FIG. 1 shows an embodiment of a computing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

The system may also include an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. In one embodiment, the mass storage may include or be implemented as a database for storing enterprise architecture information. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing means in the form of processors 101, storage means including system memory 114 and mass storage 104, input means such as keyboard 109 and mouse 110, and output means including speaker 111 and display 115. In one embodiment, a portion of system memory 114 and mass storage 104 collectively store an operating system such as the AIX® operating system from IBM Corporation to coordinate the functions of the various components shown in FIG. 1.

It will be appreciated that the system 100 can be any suitable computer or computing platform, and may include a terminal, wireless device, information appliance, device, workstation, mini-computer, mainframe computer, personal digital assistant (PDA) or other computing device.

Examples of operating systems that may be supported by the system 100 include Windows 95, Windows 98, Windows NT 4.0, Windows XP, Windows 2000, Windows CE, Windows Vista, Macintosh, Java, LINUX, and UNIX, or any other suitable operating system. The system 100 also includes a network interface 116 for communicating over a network. The network can be a local-area network (LAN), a metro-area network (MAN), or wide-area network (WAN), such as the Internet.

Users of the system 100 can connect to the network 116 through any suitable network adapter 106, such as standard telephone lines, digital subscriber line, LAN or WAN links (e.g., T1, T3), broadband connections (Frame Relay, ATM), and wireless connections (e.g., 802.11(a), 802.11(b), 802.11(g)).

As disclosed herein, the system 100 includes machine readable instructions stored on machine readable media (for example, the hard disk 104) for capture and interactive display of information shown on the screen 115 of a user. As discussed herein, the instructions are referred to as “software” 120. The software 120 may be produced using software development tools as are known in the art. The software 120 may include various tools and features for providing user interaction capabilities as are known in the art.

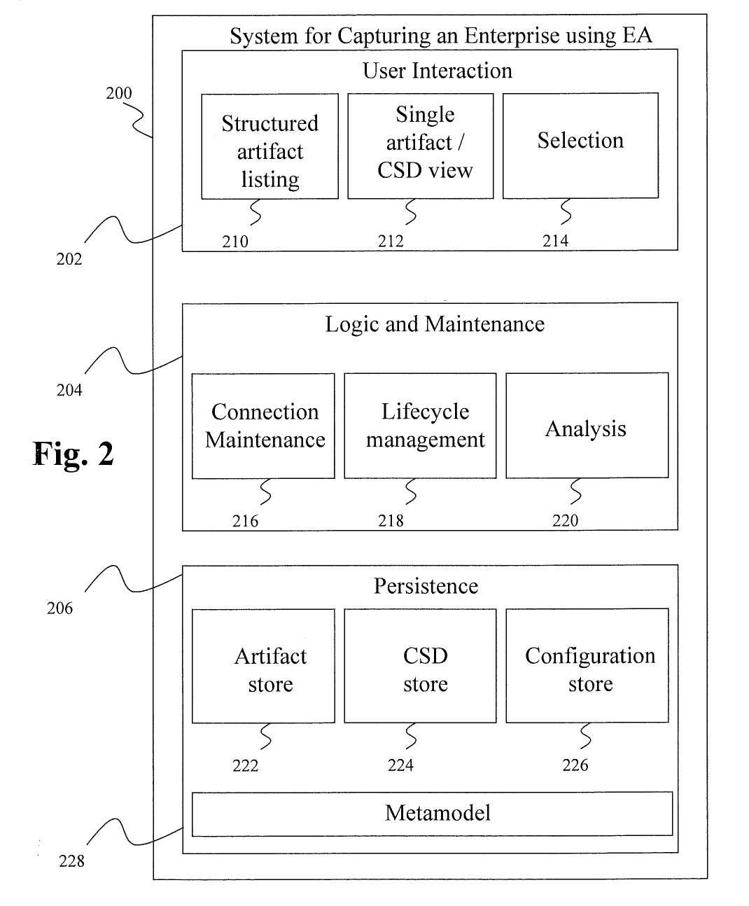

FIG. 2 shows a hierarchical system 200 according to one embodiment of the present invention. The hierarchical system 200 may be stored in any type computer memory, executed in any implementation of system 100 (FIG. 1) and may be stored on one or amongst many interconnected computers.

It should be understood, and is described in greater detail below, that certain building blocks are utilized in the present invention. The most basic building block is referred to herein as an artifact. An artifact may be any type of document or entity that is stored in the EA system. Each artifact may have specific attributes. In one embodiment, the attributes are semantic attributes such that the EA may be implemented as a semantic network. A semantic network is often used as a form of knowledge representation. It is a directed or undirected graph consisting of vertices, which represent concepts, and edges, which represent semantic relations between the concepts.

Each artifact is stored and, where applicable, linked to other artifacts. The interconnections between artifacts are also stored, as well as lifecycle information related to the artifact. The interconnections may be referred to herein as a connection, link, or reference. In one embodiment, a connection between two artifacts is always a bi-directional connection. That is, for example, the connection between artifacts A and B is actually two connections, a connection from A to B and a connection from B to A. The link from artifact A to artifact B may be referred to herein as a forward link and the link from artifact B to artifact A may be referred to as a reverse or backward link. Links may be stored within the artifacts.

Additional information about each link may be stored in a connection support document (CSD) that provides information about a particular connection between two artifacts. The CSD points to both artifacts (i.e. has a pointer to artifact A and artifact B) and may also include additional arbitrary name-value-pairs. For example, in the context of a supply stream modelled as an EA, the CSD may contain an indication how many parts represented by artifact A may be needed to produce a product represented by artifact B.

The hierarchical system 200 may include several different modules. For example, the hierarchical system 200 may include a user interaction module 202, a logic and maintenance module 204, and persistence module 206.

In one embodiment, the user interaction module 202 includes some or all of the components that allow a user to create, read, update, delete and list the database contents. That is, the user interaction module 202 may allow for artifacts to be created and linked to one another. As in all EA applications, such abilities are vital for effective EA usage because EA information, at the artifact level is manually maintained. The interaction module 202 may include, a structured artifact listing 210, a single artifact/csd (connection support document) view 212 and a selection component 214.

The structured artifact listing 210 may allow for listing a set of artifacts (that is a subset or equal to the set of all artifacts in the database). The artifacts satisfy certain conditions (such as being of a certain type and/or having a certain lifecycle status). The listing can be grouped by any property of an artifact, e.g. artifact type, category or lifecycle status.

The single artifact/CSD view 212 may show one artifact or connection support document (connection support documents can be reached by the user via linking in the single artifact view). This module may be called whenever an artifact is opened from the structured artifact listing 210. It may allow for viewing and editing all properties of the artifact (except its type). It also allows the creating of links to other artifacts. Connection support documents may also be presented to the user as such links. After editing, saving of documents is possible that ensures that logic (in the logic and maintenance module 204) is called, as appropriate, to ensure consistency and accuracy of data.

The selection component 214 may be used in single artifact views when editing an artifact. The selection component 214 may also allow for choosing other artifacts the particular artifact is to be linked to.

The system 200 may also include a logic and maintenance module 204. The logic and maintenance module may be called whenever artifacts or CSDs are edited and saved or based on explicit user invocation. It ensures both data correctness and accuracy and handles lifecycle and other analytical functions. The logic and maintenance module 204 may include a connection maintenance module 216, a lifecycle management module 218 and an optional analysis module 220.

The connection maintenance module 216 may be configured to ensure that connections are always bi-directional and consistent. When a connection is specified (by configuration) as one that has no CSD attached with it, both linked artifacts are updated so that both references and data presented to the user are always consistent. That is, whenever a “forward” link is made from artifact A to artifact B that link is stored as a part of artifact A. In addition, a reverse link, from artifact B to artifact A, is stored in as part of artifact B. When a connection is specified (by configuration) as one that has a CSD attached with it, all of the before applies as well plus the CSD is created if it has not already been created. Furthermore, both linked artifacts and CSD's are updated so that both references and data presented to the user are always consistent. That is, whenever a “forward” link is made from artifact A to artifact B that link is stored as a part of artifact A. In addition, a reverse link, from artifact B to artifact A, is stored in as part of artifact B. Further, in the event that a CSD is created, the CSD is configured to point to both artifact A and artifact B. Likewise, when a “forward” link from A to B is modified (i.e. altered, added, or deleted), the “reverse” link from B to A is also modified (i.e. altered, added or deleted). In the event that a CSD is specified that points to A and B, this CSD is also deleted when the links are deleted.

The lifecycle management module 218 may be configured to handle management of lifecycle aspects of the present invention. For example, a particular artifact may be related to a software application that has a license term or expected lifecycle. In one embodiment, the user may not be to view or edit this lifecycle information based on particular settings. The lifecycle management module 218 may also be configured to handle notifications, possibly via e-mail or similar mechanisms outside the system when documents are due for updates and determines who is responsible for implementing or reviewing a particular update.

The optional analysis module 220 may be configured to analyze connections based on user-desired criteria. In addition, the analysis module 220 may allow for the generation of reports showing information from the database. For example, the analysis module 220 may be utilized to examine whether particular business practices are following defined patterns or protocols.

The persistence module 206 may be configured to summarize all functions to store the information in a way that is persistent (i.e. database functionality). In one embodiment, four pieces of information need to be stored and retrieved based on properties or links. These pieces of information include the artifacts themselves along with all properties, which are both stored in artifact store 222, the CSDs stored in the CSD store 224, and the configuration settings stored in configuration store 226. The configuration store 226 may store, for example, when a CSD is to be created, which categories exist, whom to send notifications, and choices in picklists. The information may also include the metamodel stored in the metamodel store 228. This information defines the structure of the artifacts that can be used. These structures are referred to as metamodels.

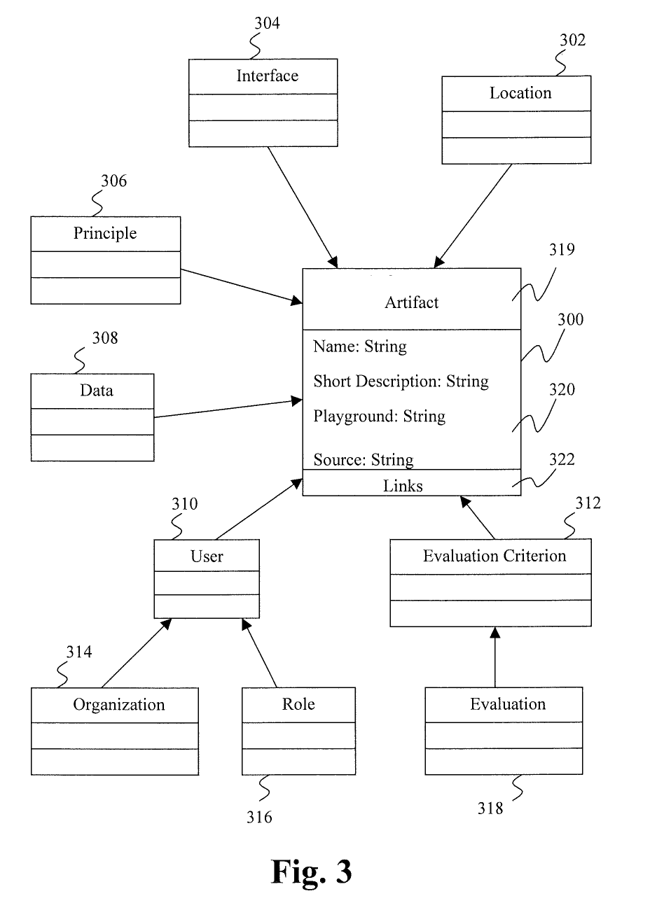

FIG. 3 is an example for a metamodel as it can be stored in the metamodel store 228 (FIG. 2). In FIG. 3 several examples for artifacts are shown. In one embodiment, Principles, Interfaces, Locations, etc. are all specific types of artifacts. Roles are specific types of users and in turn also specific types of artifacts. In addition, it should be noted for each element shown in FIG. 3, there may be several instances created to capture information about an enterprise. For instance, “Bill” and “Ted” may be two instances of a “user”. FIG. 3 is shown according to the Unified Modeling Language (UML) standard. Of course, a person of skill in the art may derive a concrete implementation from the metamodel shown in FIG. 3.

The connections according to embodiments of the present invention are implemented as bi-directional connections. According to embodiments of the present invention, artifacts may be able to refer to almost any kind of information. For non-limiting examples, artifacts could refer to locations, components, patterns, principles, standards, business components, processes, interfaces, data, users, organizations, strategy, roles, evaluations, evaluation criteria or any other type of information that may be quantified as desired by a particular enterprise.

In one embodiment, each artifact may have metadata associated with it. For example, each artifact may include a title, a type, detailed semantic information, a linking collection that may includes a separate section for each type of different link, a map from an artifact to a particular link type, and a link to a graphical representation for the particular artifact.

By keeping a listing of links, a particular artifact 300 may serve as the basis for generating the graphical representation of connected artifacts. For example, examination of all links of the artifact 300 may reveal 0 to n instances of each of the artifacts 302, 304, 306, 308, 310, 312, 314, 316 and 318. This will depend on the configuration stored in the configuration store 226.

The artifact 300 may include an artifact type 319. The title, in some embodiments, may represent the type of artifact the artifact is as well as a caption distinct for each instance of the artifact. For example, artifact 302 is a location artifact (with instance name e.g. “Data Center”), artifact 304 is an interface artifact (with instance name e.g. “RTGS+”), artifact 306 is principle artifact (with instance name e.g. “Use of open standards”), artifact 308 is a data artifact (with instance name e.g. “Customer Information”), artifact 310 is a user artifact, artifact 312 is an evaluation criterion artifact, artifact 314 is an organization artifact 314, artifact 316 is a role artifact and artifact 318 is an evaluation artifact (with appropriate captions). These artifacts, and others, may be any type of data structure that can be stored in a computer memory, e.g. a database entity, a Lotus Notes document, an XML document, a word processing document, a spreadsheet, or any other type of description of a real world item.

The artifact 300 may also include a link store 322. The link store 322 may include, in one embodiment, all other artifacts to which the artifact 300 is connected. In one embodiment, each type of artifact has its own “type” of connection/link.

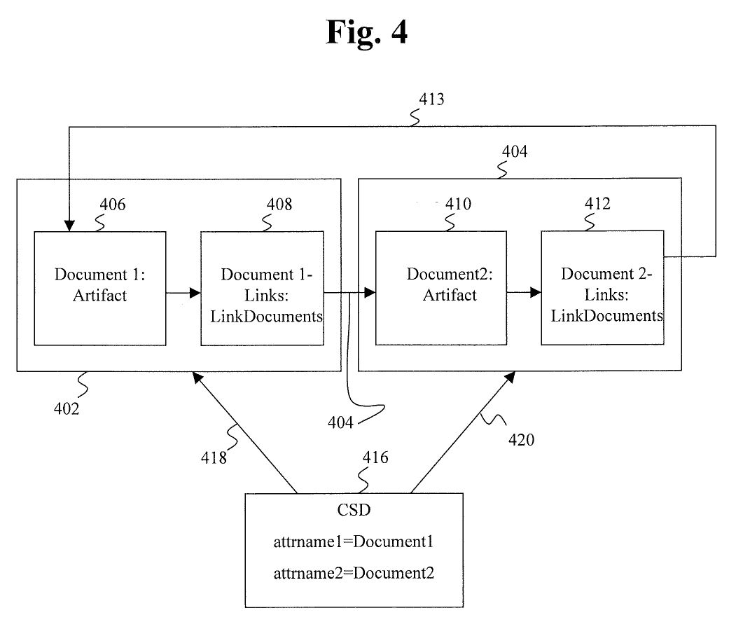

FIG. 4 shows a more detailed depiction of links/connections between a first artifact 402 and a second artifact 404. In this example, both the first artifact 402 and second artifact 404 are represented as documents. Of course, and as discussed above, the first and second artifacts 402 and 404 could be any type of artifact.

The first artifact 402 includes a document identifier 406 (Document 1) and a links portion 408. The identifier 406, in this case, indicates the artifact type, title, and other properties. The links portion 408 may, in some embodiments, contain a listing of all the links to other artifacts to which the first artifact 402 is linked. It should be noted that more than one type of link may exist. For example, a different type of link for each type of artifact may exist. For example, a special link may be declined for pattern links.

As shown, the first artifact 402 is linked to the second artifact 404 by a forward link 407. The second artifact 404 contains a document identifier 410 (Document 2) and a links portion 412. The links portion 412 of the second artifact 404 includes a reverse link 409 which points back to the first artifact 402.

In FIG. 4, the first and second artifacts 402 and 404 are also pointed to by a CSD 416 as indicated by connections 418 and 420, respectively. Some artifacts may not include a CSD. Thus, FIG. 4 is by way of example only.

According to embodiments of the present invention, each CSD connects two and only two artifacts. A CSD maybe created by user interaction when a connection between two artifacts is first made or at a later time. In some embodiments, the CSD may be automatically created for any link as it is created. In general, CSD's contain additional information about a particular link. For instance, if the supply chain of an enterprise is being documented, the CSD may include information about the number of parts produced by the organization represented by the first artifact 402 are needed by the organization represented by the second artifact 404. The information contained in a CSD is not limited in any way. In some embodiments, the information may be compliance information that define business requirements for the link. For instance, the CSD may be describing the link between two information technology (IT) components and may indicate, for example, the number of user terminals that may be connected to a single network hub. In such an instance, the first artifact 402 may indicate the number of user terminals in a particular location and the second artifact 404 is the network hub. The CSD 416 may contain information relating to the number of connections allowed. In one embodiment, comparing the numbers of user terminals connected to particular network hubs and knowing the limits may allow, for example, an IT planning process to redistribute connections to meet existing hardware or allow for forward planning of hardware procurement or redistribution.

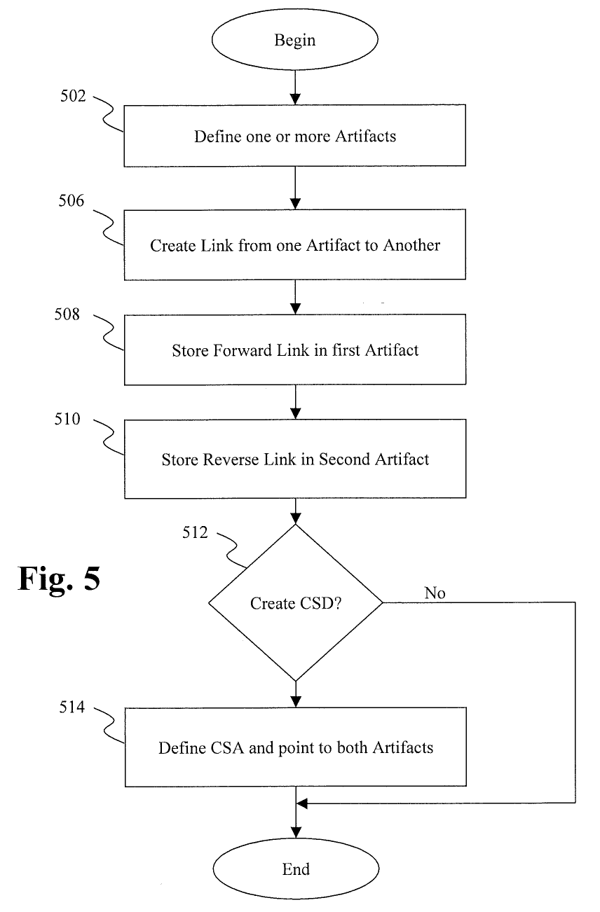

FIG. 5. shows a flow diagram of a method according to one embodiment of the present invention by which an EA architecture may be captured and stored. At a block 502 one or more artifact are defined. As discussed previously, each artifact may represent any portion of a business process or other information that may be gathered by enterprise architecture. In one embodiment a definition of an artifact includes giving it a type, a name, and other related information. As discussed previously, information for each artifact may be gleaned manually from an examination of the operations of a particular enterprise.

At a block 506, a link between one artifact and another artifact is created. The link may be created, for example, by implementing the functionality of the user interaction module 202 (FIG. 2). As discussed previously, the link may be from one type of artifact to another type of artifact. Thus, the link from the first artifact to the second artifact can be created in several different manners. For instance, each artifact could be given an icon which represents it and in an environment according to the present invention one may drag and drop links between the two. Of course other types of representation are possible and other types and means for creating the links may be within the scope of the present invention.

At a block 508, a forward link is created from the first artifact to the second artifact. This link is stored with the first artifact in the link section associated with the particular artifact as discussed above.

At a block 510, a reverse link is stored from the second artifact to the first artifact. The reverse link is stored in the link second associated with the second artifact. In this manner, each link between two artifacts is represented as two separate links and ensure bidirectional links between any two linked artifacts.

At a block 512 it is determined whether a CSD is desired for the particular link. In one embodiment a user determines whether a CSD is to be created. In another embodiment a CSD may automatically be created for every link. In yet another embodiment, a CSD may automatically be created for a configured set of links. In the event that a CSD is not created, the method shown in FIG. 5 ends. However, if a CSD is to be created, at a block 514 a CSD is defined which includes pointers to both the first artifact and the second artifact. The CSD may also include additional information related to the link as described above.

Of course, the processing performed in blocks 508-514 may be repeated until all of the desired links between artifacts have been created. In addition, and as described below, the links may also be modified (altered added, removed) at a later time.

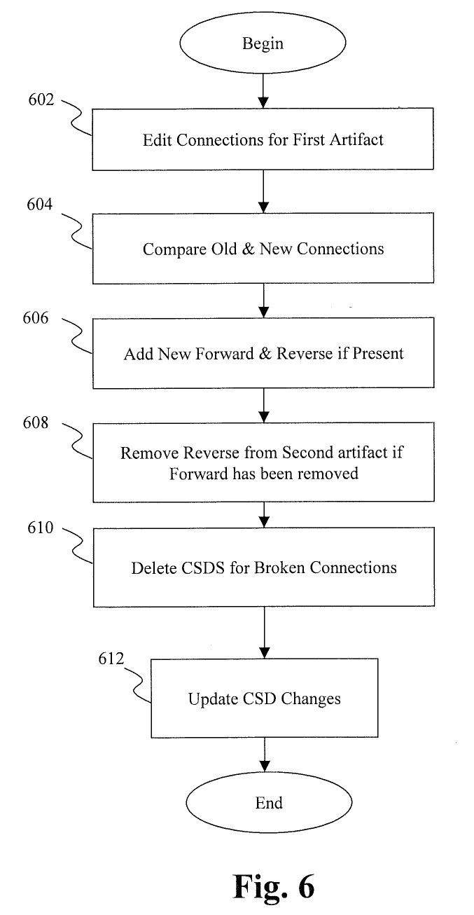

FIG. 6 is an example of a method according to one embodiment of the present inventions by which connections between a first artifact and another other artifact to which it is linked (e.g., a second artifact) may be modified. At a block 602 a connection is modified. This may be accomplished, for example moving one end of the link to a different artifact or deleting a link. In one embodiment, this may be accomplished by utilizing the user interaction module 200 (FIG. 2).

At a block 604, the old links related to the first artifact are compared with the new links. This may include keeping a log of any variations in the links whether they be a variation in the connection or any information related to the connection. Another embodiment of this could be storing the current and previous set of links for each artifacts to determine which links were deleted and to use this information to trigger the deletion of the “reverse” links. At a block 606, any new link that has been created has a forward link in the first artifact and a reverse link in the second artifact created and stored with its respective artifact. This ensures the bidirectional link nature of embodiments of the present invention. Of course, if a new CSD is created between any two artifacts, the two artifacts are pointed to by that CSD and the new CSD is saved.

At a block 608, any reverse links from the second artifact are removed if any forward link has been removed. This may be accomplished, for example, by the connection maintenance module 216. At a block 610, any CSD for a deleted connection is deleted. At a block 612, any changes to any CSD due to changes in the links are updated and saved. This can for instance be the title of the CSD if this title contains the names of the two artifacts the CSD refers to. Likewise, artifacts can be updated when they contain copies of values from the CSD. These updates are one possibility for an embodiment and might not be necessary in other implementations.

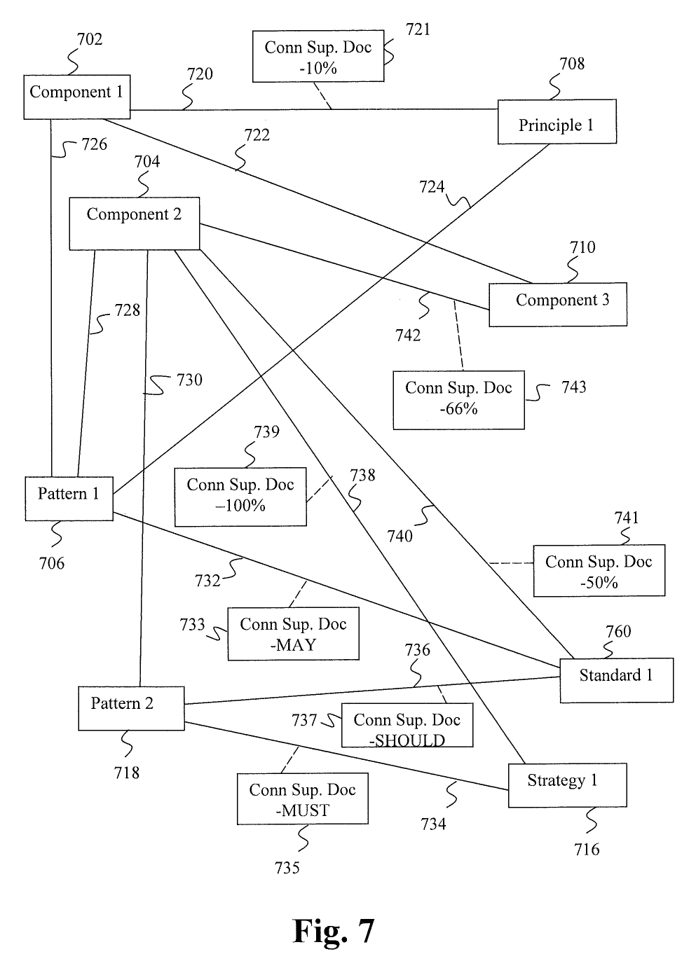

FIG. 7 shows an example of a network of interconnected artifacts according to one embodiment of the present invention. As shown, each square box represents either an artifact (ending in an even number) or a connection support document (ending in an odd number). Each link between two artifacts is shown as a solid line. The connection support document related to the link is connected to the link with a dashed line. As discussed in greater detail above, the connection support document actually points to the two artifacts, which are connected by a particular link. Each of the artifacts shown in FIG. 7 is either a component, a pattern, a strategy, a standard, or a principle. It should be understood that these artifacts are by way of example only and any of the previously discussed artifacts may be implemented.

As shown, component 1 702 is coupled to principle 1 708 by link 720, to component 3 710 by link 722 and to pattern 1 706 by link 726. The link between component 1 701 and principle 1 708 also includes a connection support document 721. In this example the connection support document 721 indicates that at least 10% of the time, component 1 702 forms a portion of principle 1 708. It should be understood that the indications shown in the CSD's of FIG. 7 are by way of example and these indications could be any type of indication based on user requirements. For example, the indications (or rules) contained in the CSD's may include, but are not limited to, pattern requirements, criticality, properties, standards and the like.

Component 2 704 is coupled via the links 728 to pattern 1 706, via the link 730 to pattern 2 718, via the link 738 to strategy 1 716, via the link 740 to standard 1 760, and via link 742 to component 3 710. The links 738 and 742 also include connection support documents 739 and 743, respectively indicating, respectively, that link 738 requires 100% compliance and link 742 require 66% compliance.

Pattern 1 706 is coupled to principle 1 708 by link 724 and to standard 1 760 via link 732 which includes a connection support document 733. Pattern 2 is coupled to standard 1 760 via link 736 and to strategy 1 716 via link 734. Link 736 includes a connection support document 737 indicating that the pattern should be part of the standard and link 734 is a MUST link as indicated by connection support document 735.

In one embodiment, connections can be analyzed utilizing, for example, the analysis module 220 (FIG. 2). A simple analysis may be performed, for example, by listing all interconnected artifacts. An example of such a listing may take the form, for example, of that shown in FIG. 7. In another embodiment, algorithms may be applied that analyze information about each of the artifacts to prepare a report. For example, a listing of all projects that utilize outdated products (based on the lifecycle information) may be generated. Further, embodiments of present invention may allow for algorithms to read the structured data contained in the artifacts and generate reports or other information there from. In another embodiment, connection support documents are looked up by searching for all connection support documents and selecting the one that references both artifacts connected by a particular connection.

Advantageously, storing and organizing the data related to EA as described above may allow greater modeling flexibility. For example, many models (in the EA space and beyond) were created and afterwards the static nature of the documents made them difficult to change without revising huge documents entirely. Further, in the past, each document was limited in scope and not connected to adjacent models. As such, information was stored in different and separate places and connecting them was intellectual work and necessary time and time again. The system presented here overcomes these obstacles with a new approach: information of very different types can be interconnected; small portions of it can be changed at any time as their direct neighbors do not have to be searched from documents; and new types of information can easily be added.

Embodiments of the present invention may be utilized to provide automated assessment of the semantically stored enterprise architecture that includes stored components (also referred to artifacts), patterns and other artifacts in a database. In this environment, there may exist patterns that govern the interconnection of certain artifacts and these patterns, as well as components, may be linked to other artifacts. In addition, components may be linked to patterns. In addition, embodiments of the present invention may allow for the storing of additional information (parameters) in the patterns against which to assess components. This information may be stored, for example, in connection support documents (CSD's). This information may be used to assess whether particular connections include the components. From this information, the level to which particular patterns are implemented may be assessed. Further, weighting of components may be useful in helping to identify improvement points.

Embodiments of the present invention may allow for existing and reference architectures to be created and stored in database system. The basic building block of these architectures is the artifact. One key type of artifact is referred to herein as a component. The sum of all artifacts and thus information stored in the systems is the universe of discourse. Enterprises can be described as the sum of components, these are further described by additional information such as strategies and principles. (These components and other artifacts can be stored in the database system.) The storage of this information may include semantic information, i.e. information that can be read, interpreted and analyzed by a computer system. This allows automated analysis. Semantic storage will include references linking artifacts together as discussed above.

According to embodiments of the present invention, patterns (yet another type of artifact) may be defined and stored in the database as well. In one embodiment, a pattern can serve as a template for one or several components. Patterns can be linked just like components (as they are templates for them); however, they can also be linked to the components that are supposed to realize the pattern. As described in greater detail below, based on the patterns and the semantic storage, it may be possible to determine how well components implement the patterns they are supposed to implement, how well the components meet parameters, how well the component is linked to artifacts the pattern is also linked to (and thus mandates for implementation by components) and how important each component is for a company. As an aggregated result: an enterprise architecture assessment including the top 3/5/10/ . . . components whose improvement makes a difference (or more exactly: the most difference according to deviation and business criticality) may be determined.

These patterns may have as their source (amongst others) the business and IT governance of an enterprise, i.e. the sum of all standards, rules and procedures that projects and BaU (Business as Usual) operations are to follow.

As discussed above, for assessment purposes, special artifacts referred to as patterns form the foundation element. In short, patterns can have parameters to check against. In more detail, a pattern links to other artifacts specifying whether derived components may/should/must (not) link to these as well (where linking means e.g. implementing, conforming, etc.)—both positive (may/should/must) and negative (may not/should not/must not) connections are possible and can be rated (the CSD may be required to determine whether this is a connection used as pattern or—if omitted—as pattern implementation). Components save their criticality, i.e. how important they are for the business. CSDs specify the extent (weight of linkage) they implement, conform, etc. to other artifacts in the CSD of the component-artifact linkage. Likewise, the CSD of the pattern-artifact linkage saves the policy in terms of can/should/must (not).

Patterns are the foundation of the assessment. They are compared with components to determine to which extent the components differ from the patterns (which they are supposed to follow as closely as possible). Patterns determine requirements for components in two ways: Links to other artifacts with a pattern_link in the CSD and each component also needs to have a link (then, its not a pattern_link) to the artifact to be compliant. This link can give an extent of compliance (100% by default). Parameters that determine properties the component has to follow (has to link to no more than 10 business functions, etc.)

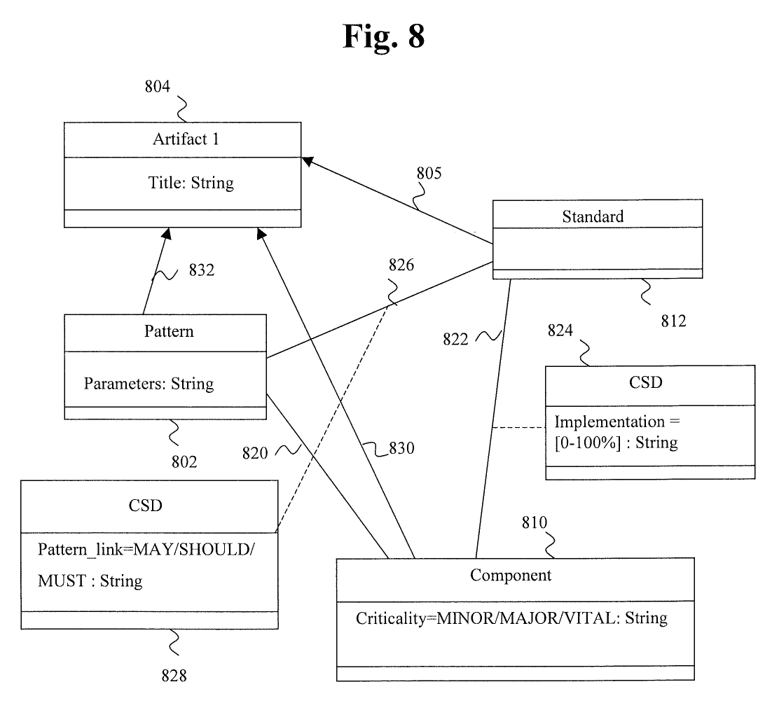

FIG. 8 shows a class diagram for a pattern 802 which is one type of an artifact 804—just like components 810 and standards 812. The links 805, 830, 832 are to be interpreted as generalizations as standardized by the Unified Modeling Language (UML).

A pattern 802 can mandate parameters to be followed or an mandate links (where links mean adherence/implementation) to other artifacts as in this example a standard 812, a CSD 828 specifying a pattern-link is required for the link 826. A link without CSD data required specifies a component implements a pattern—this is depicted by link 820 stating that components 810 are supposed to implement a pattern 802. Finally, the component 810 links to the standard 812 via link 822 stating in a (mandatory) CSD 824 the extent of implementation.

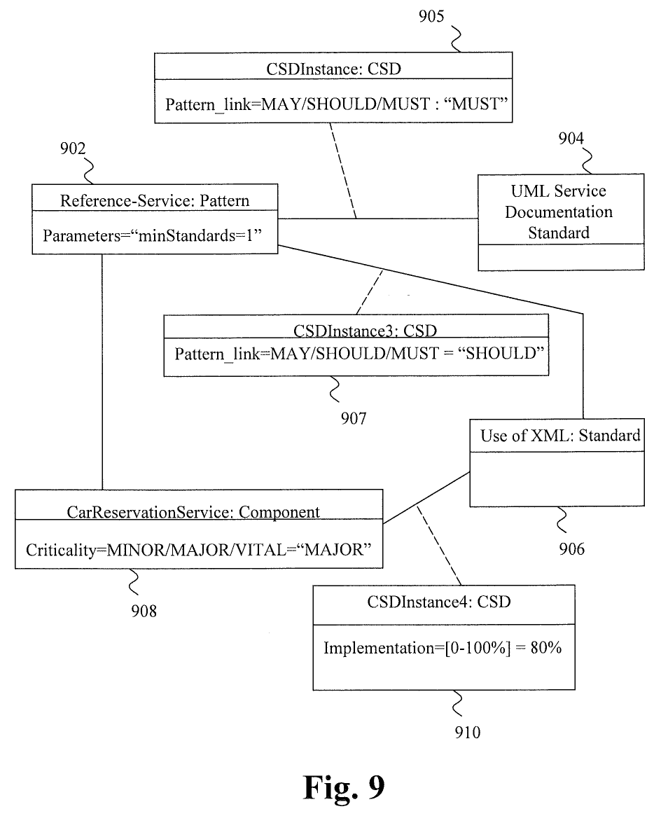

FIG. 9 shows a more detailed depiction of a patterns, standards, and components in the context of a business operation. A pattern 902 may include particular requirements. In this example, the pattern 902 demands usage two standards. In particular, pattern 902 demands usage of UML for documentation 904 (a standard) as a MUST as indicated by CSDIinstance 905 and usage of XML 906 (a standard) as a Should criteria for compliance (the link to the component is not a pattern criteria as it is not pattern_link) as indicated by CSDInstance3 907, CSDInstance 905. Pattern 902 also has a parameter mandating implementations to follow at least one standard.

The pattern 902 also is coupled to a component 908. In this example, the component 908 that is supposed (and asked) to implement the pattern implements the usage of XML at an 80% level (the use of UML is 0) as indicated by CSD instance 4 910.

The example shown in FIG. 9 is basic building block for further analysis of the entire system.

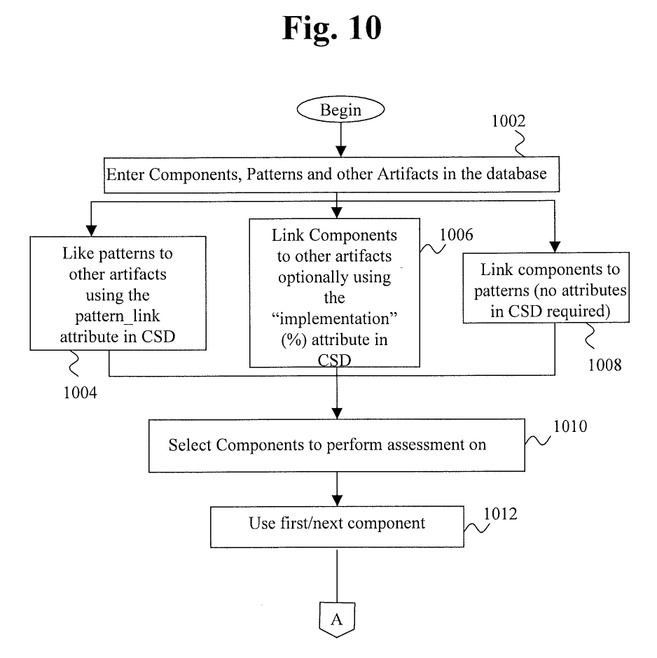

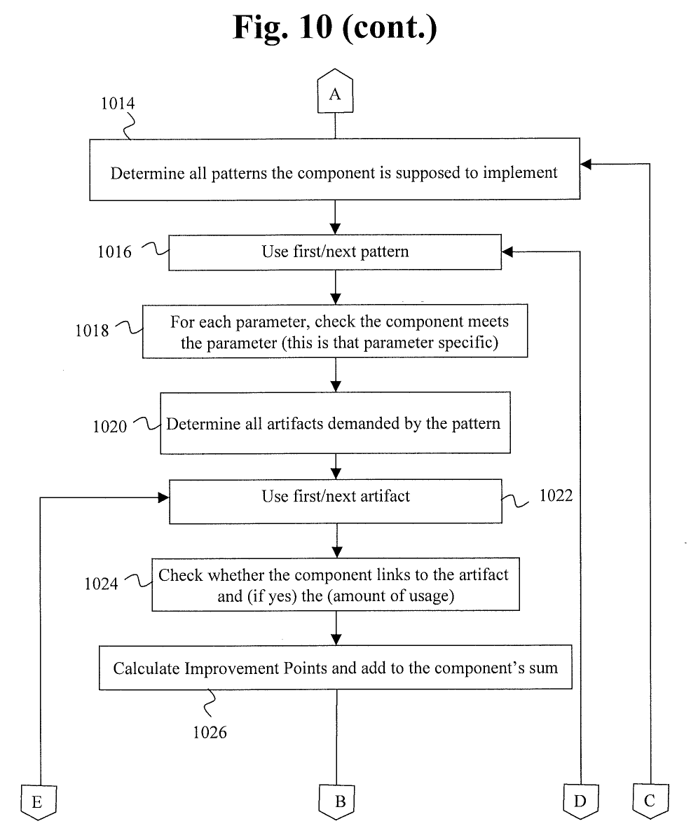

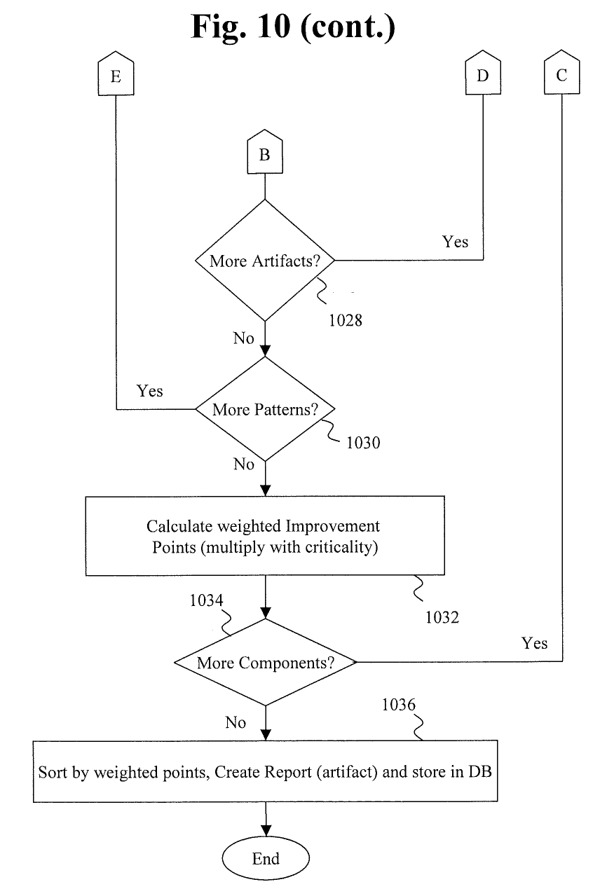

FIG. 10 shows a method of determining the compliance of business enterprise to required patterns. This method may be carried out by an evaluation module included in the enterprise architecture module of the present invention. For example, the logic and maintenance module 204 (FIG. 2) may include an analysis module 220 for performing the method describe below.

At a block 1002 patterns, components, standards and other artifacts are entered into the system. As described above, the number and types of artifacts is not limited. For purposes of the explanation of FIG. 10 it is assumed that one or more patterns have been entered. In addition, it is assumed that multiple artifacts, CSD's and components have been entered.

At a block 1004 patterns are linked to other artifacts using the pattern link attribute in a CSD. An example of this may be seen by the linkage of pattern 902 to standard 908 and the CSD 905 as shown in FIG. 9.

At a block 1006 components are linked to other artifacts in the event that an implementation percent attribute is present. An example of this shown by the connection between component 908 and the XML standard 906 by CSDInstance 4 910 which states 80% compliance of the component 908 using XML as shown in FIG. 9.

At a block 1008 components are linked to patterns. The pattern 902 in FIG. 9 is linked to component 908. In one embodiment, the processes described in blocks 1004, 1006 and 1008 may be done simultaneously or in series. In one embodiment, the process shown in FIG. 10 does not progress until the processing in all of blocks 1004, 1006 and 1008 are completed. Of course, this is not required and processing may move jump to block 1010 as soon as the processing in anyone of blocks 1004, 1006 or 1008 is completed. In one embodiment, there may be no means to ensure meaningfulness of the processes performed at blocks 1004, 1006, 1008 in an automated way; however, for meaningful analysis, all of 1004, 1006, 1008 have to be performed for the subset of data (or more specifically: for the components to be analyzed).

At a block 1010, components upon which testing may be desired are selected. For example, and referring back to FIG. 9, the user may select a car reservation service component 908. The selection is arbitrary and may include the selection of one or more components up to the total number of components.

At a block 1012 the first or next component (assuming multiple components have been selected) to be analyzed is selected. For the component being analyzed, all patterns that particular component is to implement is selected at a block 1014. For example, the car reservation service component 908 of FIG. 9 is to implement pattern 902.

As discussed above, each pattern may include a list of parameters defining constraints components will have to meet. In addition, the pattern may include linkage of Patterns to artifacts. These mandatory contain a CSD with a pattern-link and optionally contain the extent to which implementation/conformance is necessary (all connections with implementation=must/should/may (not) in CSD).

At a block 1016, the first or next pattern associated with the component being analyzed is selected. For each parameter it is determined whether the component meets the parameter at a block 1018. Such checking may include, but is not limited to, determining if the component is utilizing the correct standards or the number of standards to implement as a minimum or any other criteria. The level of compliance may be recorded and utilized later.

At a block 1020 all artifacts demanded by the pattern are determined. In one embodiment, this may include determining all CSD's that are include an indication that a particular link is a pattern_link. For example, CSDInstance3 907 and CSDInstance 905 are pattern links are demand particular artifacts 904 and 906.

At a block 1022 the first or next artifact demanded by the pattern is selected. At a block 1024 it is determined if the particular artifact is linked to the particular component. In the event that it is linked, the extent of the usage is determined. This extent may be represented in terms of percentages or may be a simple yes (i.e. 100%) or no (no Link). Regardless, at a block 1024 improvement points are calculated. Improvement points can be calculated based on the deviation of the actual implementation and the mandated implementation in 1026 plus the level of mandate (‘can’/‘may’/‘should’/‘must’-‘not’).

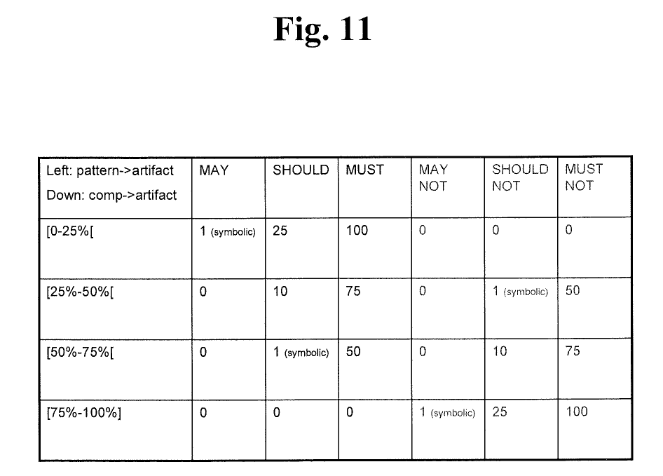

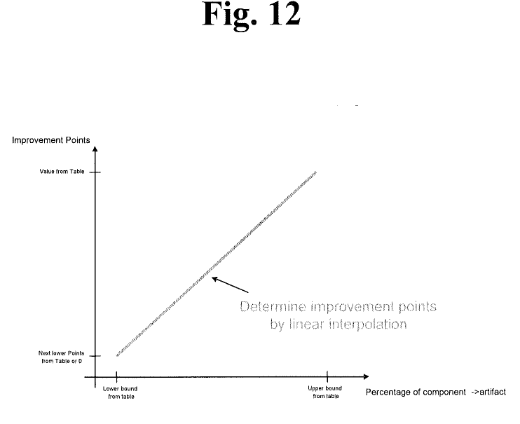

FIG. 11 shows a table that may be used in the calculation of improvement points. So (as one of several possible implementations), for a ‘must’ implementation, 100 improvement points are assigned when the actual component implements less than 25% (according to the CSD), 75 improvement points for 25% to excl. 50%, 50 for less than 75% and nothing when above. The same applies for ‘should’, e.g. 25/10/1 (symbolic) or for ‘may’ (1 symbolic, 0, 0, 0). The same approach applies vice versa for ‘ . . . not’ when there is an implementation. This is one of several possibilities. Another could be interpolation instead of or in addition to the simple table of FIG. 11. An example of a graph used for such interpretation is shown in FIG. 12.

Referring again to FIG. 10, for each component, a running total of improvement points may be added to the score for the particular component at a block 1026. This score is incremented for each pattern and associated artifact in the manner described above.

At a block 1028 it is determined if more artifacts are related to the particular pattern being analyzed remain. If so, processing returns to block 1022. If not, at a block 1030 it is determined if there are more patterns associated with the particular component being analyzed. If so, processing returns to block 1016. If not, a weighted improvement score is calculated at a block 1032. This may include multiplying the improvement score by the criticality of the component.

As shown in FIG. 9, the criticality of the car reservation service component 908 is “Major.” This means that this component is an important business component for the enterprise. In one embodiment, criticality may be measured on a minor/major/vital scale. Discrete values, such as, for example, 33%, 66% and 100% may be assigned, respectively, to each of the minor/major/vital distinctions, respectively. Of course, any other scaling could be applied as could other levels of granularity depending on the context.

Regardless, at a block 1034 it is determined if there are any more components to be analyzed. If so, processing returns to block 1036. If not, the “information gathering” is complete and processing is passed to optional block 1038. At block 1036 the weighted improvements scores for each component may be sorted by score order. This sorted list may indicate the components that most need attention in a particular enterprise. In one embodiment, the sorted list may be stored in the system as an artifact.

Embodiments of the present invention are directed to utilizing an automated EA system to aid in the creation of an IT plan. In one embodiment, the present invention may include information and linkages from documents/objects in a EA database, such as projects, components and systems with their associated products. This information may be compared to product lifecycle information in an effort to suggest alternatives based on the product lifecycle information, adoption policy and specified dates. In one embodiment, the suggested improvements may be weighted to determine most important actions. This may allow for the maintenance EA documentation and assessments of the vitality of a current IT environment.

The applicability of this embodiment of the present invention may be understood in a particular context. Suppose a financial services company wants to be up to date with its software but it does not want to carry the costs of early adopting, i.e. the enterprise opts to choose the 2nd newest software product version for all critical applications (i.e. a normally more stable and bug free version) and the 2nd last still supported version (normally most cost-effective—used licences) for all others.

As resources are limited, the company decides to focus on mission-critical applications first, e.g. its “payments” application (which is absolutely mission critical as it handles the company's cash transaction) or its Customer Relationship Management system and—in case of doubt—cut spending for less important ones like “Order Business Cards” or “Holiday Planning”. The company thus assigns the payments application a high criticality and the other application a low one.

To plan spending for the next year, the company wants to know which software to acquire and runs an analysis based on December 31st of the upcoming year to determine the need up to this point. The company has this information input into the enterprise architecture system of the present invention with the vendor's product information (both products and product versions which are linked), its enterprise components (including their criticality) (e.g. “Payments”, CRM, Business Cards, Holiday), its policy concerning updates (specifically for high and low criticality) and the connections from components/applications to product versions

Embodiments of the present invention may then analyze which software product version currently runs each of the applications and realizes that a new version of the product running “Payments” will be released (which causes a new 2nd newest as well) and the product version running “Holiday Planning” runs out of support and would have to be replaced in order to mitigate any risk and risk response to the vendor.

“Payments” is more important. As such, according to embodiments of the present invention, the enterprise architecture system may be configured to filter out two applications with “Payments” being the first on the list and “Holiday Planning” second.

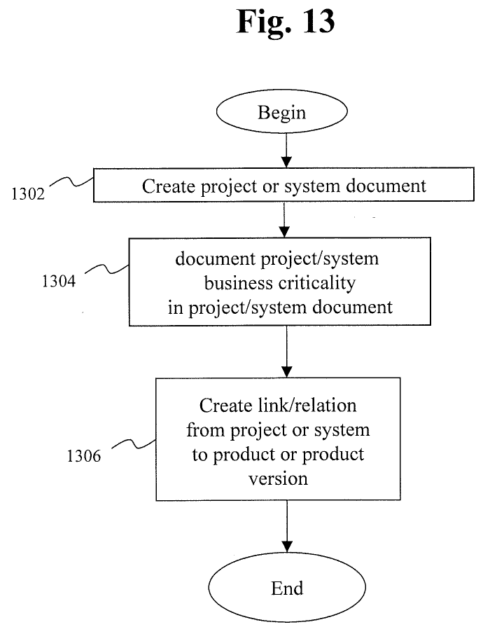

FIG. 13 shows a method of obtaining EA information for use in IT planning. At a block 1302 a project or system document is created. The project or IT system document may be a component in the EA system described above. The project may describe, for example, a particular application such as “Payments.” The project may rated based on its criticality at a block 1304. As discussed above, “Payments” should be rated higher than “Holiday Planning.” Any type of rating system may be employed. Referring back to FIG. 9, another example of a project is the car reservation system component 908 and it was rated “Major.”

At a block 1306 links are created between the project to all products related to the project. The products could include, but are not limited to, software and hardware. Each product may be a separate artifact. In one embodiment, each artifact containing product information may include or may link to product lifecycle and product version information. In another embodiment, such information or parts of it may be stored in a CSD. Of course, any link between projects and products will be a bidirectional link as described above.

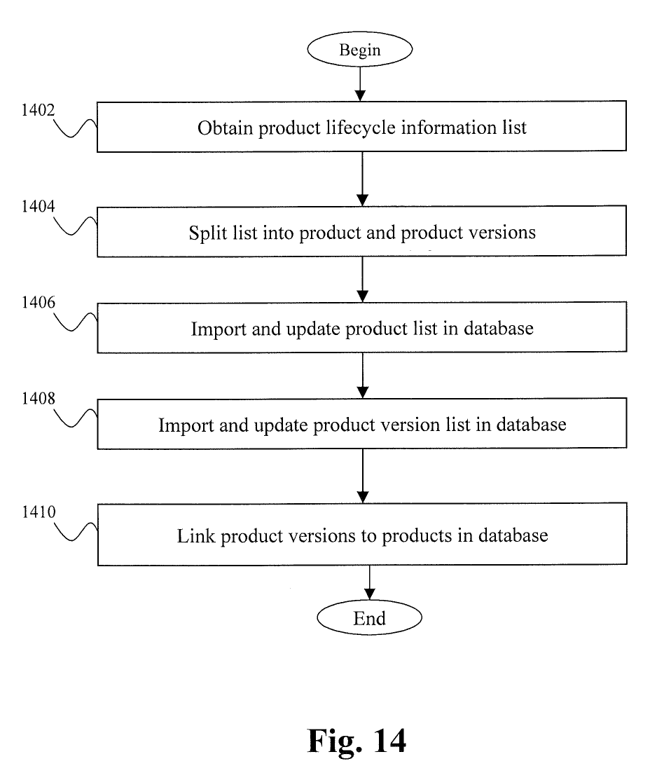

FIG. 14 shows a method of creating the information for each product that is linked to one or more product versions. At a block 1402 product lifecycle information for each product is obtained. This may be determined on supplier information or based on internal information created by the organization. Regardless, at a block 1404, the product lifecycle information list is split, for each product, into different versions. For example, a software program X may be split into programs X Version1 and X Version2.

At a block 1406 a product list is imported into the EA system or a current list is updated. This list includes, for example, all software and hardware employed by the IT department of the organization. This list may be a single list or it may be series of individual elements. Likewise, at a block 1408 the product version list is created or updated as in block 1404. As discussed above with respect to FIG. 13, at a block 1410 product versions may be linked to the products the database.

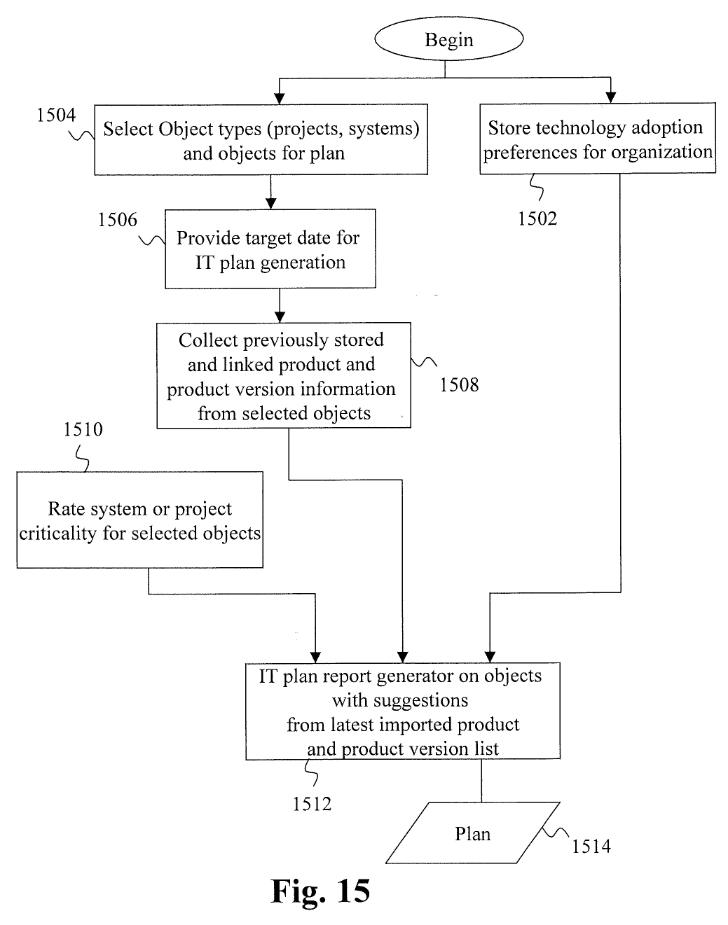

FIG. 15 shows a data flow diagram for providing IT recommendations according to one embodiment of the present invention. At a block 1502 a technology adoption preference document is created and stored in the EA system. This document may include preferences specific to a criticality rating as well. At a block 1504, the projects (either projects or systems) for review may be selected. This may be a manual or automatic process. Accordingly, at a block 1506 a target date for the IT plan generation is created. This may be either a user created date or a default date like for instance the current date. At a block 1508, for each selected project or system the linked product and product version information is retrieved from the EA system. Because each project or system is created in a manner similar to the shown in FIG. 9, this process may include merely following each link and identifying each artifact that is a product and collecting all related information.

As discussed above, some projects or IT systems are more important than others. As such, at a block 1510 the project is rated based on criticality. For example, the car reservation system component 908 was ranked at “Major” in FIG. 9. The rankings of the project, the project's products and the technology adoption preferences are all utilized by the IT plan generator 1512. Based on the rankings, the products and their expiration and the preferences, a ranked list 1514 what products need to be update/added/changed is created by the generator 1512.

Similar to the pattern assessment, this IT plan system and method is another way of performing an assessment on structured EA data as described in above with respect to the analysis model.

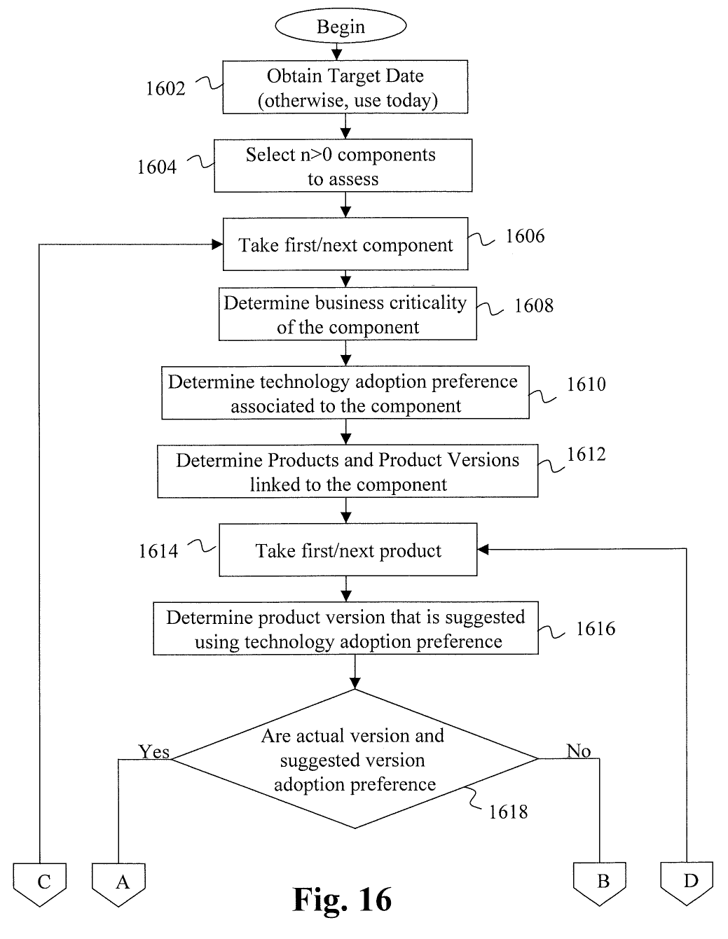

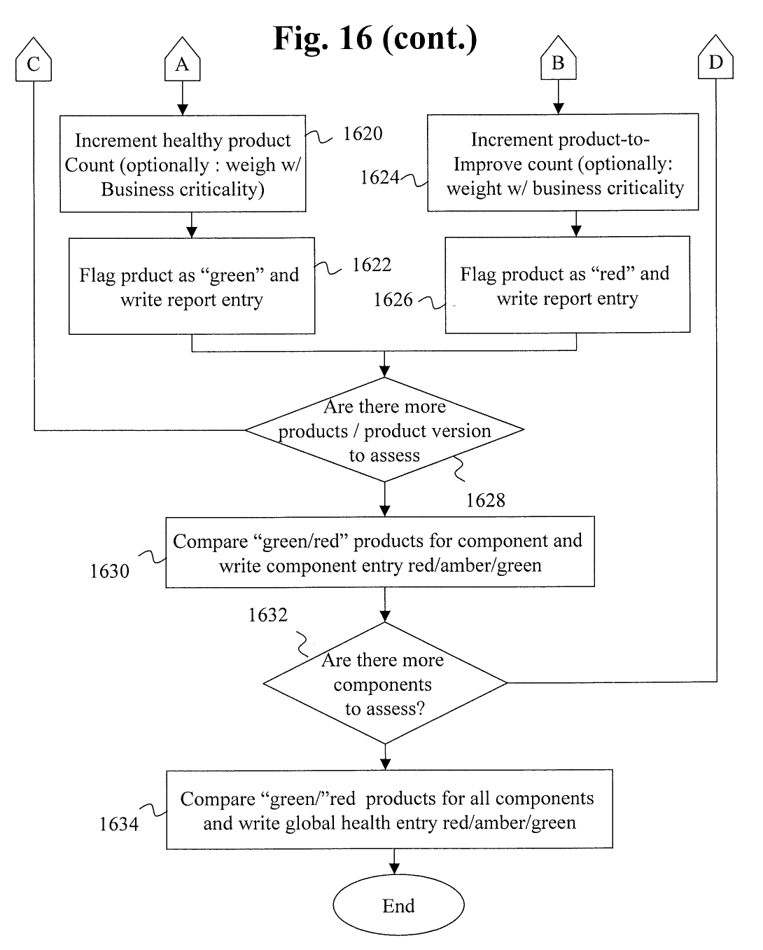

FIG. 16 describes the details of the generation process performed by the IT plan generator 1512 (FIG. 15) in the form of a flow chart. At a block 1602 a target date is received. In the event that a date is not received a default date (such as the current date) may be used. At a block 1604 the components to be analyzed are selected. In one embodiment, this may include all components. At a block 1606 the first/next component is selected. For the component currently selected, at a block at 1608 the business criticality of the component is determined and the technology adoption preference for the selected component is determined at a block 1610. At a block 1612 the products and product versions linked to the component are determined. In one embodiment, the initial value for improvement points can now be set to a neutral value (e.g. zero). This implies that based on different adoption preferences from block 1610, different policies reflecting different requirements may be anticipated.

For each product, at a block 1614 it is then determined which version is mandated by the preference (e.g. 2^{nd} newest). When the versions are the same, as determined at a block 1618, the improvement points of the product are decreased at a block 1620. In one embodiment, improvement and health might be stored using two numbers. In another embodiment, this might be one number.

When versions are not the same the improvement points are increased at a block 1624. In one embodiment, improvement points and health points might be two separate numbers. In another embodiment, they might be one number. Optionally, in one possible embodiment of the invention, the improvement/health points added/subtracted might be weighted with the business criticality by multiplication with a numerical representation of the criticality in blocks 1620 and 1624, respectively.

Depending on whether or not desired and actual version of the product are equal, the product might be flagged ‘green’ at block 1622 or ‘red’ at block 1626 for a certain project as an indicator of deviation from the optimal state.

The assessment is repeated for each product or product version linked to the project (or component) as determined at block 1628. When no version and just the product is available, a flag ‘amber’ might be set as it cannot be determined automatically whether the current implementation is optimal.

In one embodiment, not only the concrete project-product (version) combination might be flagged ‘red’/‘amber’/‘green’, but also a product/product version as such at a block 1630. In an embodiment, this might be achieved using a count of the project-product or product version ‘red’/‘green’ ‘values. In another embodiment, the improvement points might be used as a measure by defining ranges of improvements. The process of evaluating the improvement points or calculating the status for each product and product version is repeated for the scope of the assessment, i.e. every selected document (1632).

In one embodiment, the same aggregation might be performed by aggregating project ‘red’/‘amber’/‘green’ status in one global ‘red’/‘amber’/‘green’ status (1634). In one embodiment, this might be achieved by counting ‘red’/‘amber’/‘green’ status. In another embodiment, this might be achieved by adding the improvement points and defining ranges.

With the improvement points and/or ‘red’/‘amber’/‘green’ status computed for each project or component, an IT plan can be generated. In one embodiment, this might imply showing ‘red’ projects/components with high criticality first, then red with lower criticality, and so forth though this is only an example and other sort orders are possible as well.

In another embodiment, the weighting with criticality, e.g. by multiplying improvement points and with criticality can be made. In this case, the IT plan might show the projects/components with the most improvement points (i.e. the highest number of improvement points) first.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method of forming an IT plan for an enterprise utilizing an automated enterprise architecture (EA) system, the method comprising:
creating a project document, the project document describing a particular portion of operations of the enterprise;
ranking the criticality of the project as compared to other projects of the enterprise;
linking products, including product versions, that are related to the project project document in the EA system, wherein the link is a two way link;
receiving organization technology adoption preferences; and
creating a list of products to be upgraded based on the technology adoption preferences and the ranking of the project.

2. The method of claim 1, further comprising:
outputting the list to a user via a display.

3. The method of claim 1, wherein the project document is a component of the EA system and is linked to another artifact and to a connection support document.

4. The method of claim 3, wherein the link to the another artifact is two-way link.

5. The method of claim 1, further comprising:
obtaining product lifecycle information for one or more of the projects; and
including the product lifecycle information in the product.

6. The method of claim 1, further comprising:
collecting projects previously stored and linked to the project.

7. The method of claim 1, further comprising:
importing a list a new products; and
providing recommended products to upgrade to.

8. The method of claim 1, wherein is ranking is based upon predetermined factors affecting the enterprise.

9. A computer program product for producing an information technology (IT) plan for an enterprise in an enterprise architecture (EA), the computer program product comprising:
a storage medium readable by a processing circuit and storing instructions for execution by the processing circuit for facilitating a method including:
creating a project document, the project document describing a particular portion of operations of the enterprise;
ranking the criticality of the project as compared to other projects of the enterprise;
linking products, including product versions, that are related to the project document in the EA system, wherein the link is a two way link;
receiving organization technology adoption preferences; and
creating a list of products to be upgraded based on the technology adoption preferences and the ranking of the project.

10. The computer program product of claim 9, wherein the method further comprises:
outputting the list to a user via a display.

11. The computer program product of claim 10, wherein the project document is a component of an enterprise architecture (EA) system and is linked to another artifact and to a connection support document.

12. The computer program product of claim 11, wherein the link to the another artifact is two-way link.

13. The computer program product of claim 9, wherein the method further comprises:
obtaining product lifecycle information for one or more of the projects; and
including the product lifecycle information in the product.

14. The computer program product of claim 9, wherein the method further comprises:
collecting projects previously stored and linked to the project.

15. The computer program product of claim 12, wherein a desired product version can be computed by using the adoption preference based on business criticality.

16. The computer program product of claim 12, wherein a health or a deviation of a desired product to an actual product version is be determined

17. The computer program product of claim 16, wherein the deviation can be weighted with the business criticality.

18. The computer program product of claim 16, wherein the deviation can be measured as red/amber/green or as improvement points.

19. The computer program of claim 16 wherein, the deviation of current and desired version.

20. The computer program product of claim 19, wherein the deviation can be further aggregated into a global status.
